(19) United States
(12) Patent Application Publication
(10) Pub. No.: US 2016/0279005 A1
(43) Pub. Date: Sep. 29, 2016

(54) Apparatus for Reducing Contact Pressure on a Person, a Bed in Combination with an Apparatus and a Method of Preparing a Bed

(71) Applicant: Talar-Made Limited, Chesterfield (GB)

(72) Inventor: Bernard Martin CREWDSON, Chesterfield (GB)

(73) Assignee: Talar-Made Limited

(21) Appl. No.: 15/075,817

(22) Filed: Mar. 21, 2016

(30) Foreign Application Priority Data
Mar. 23, 2015 (GB) 1504831.7

(51) Int. Cl. A61G 7/057

(52) U.S. Cl. CPC A61G 7/05769

(57) ABSTRACT

An apparatus for location against an edge barrier of a bed, a bed in combination with the apparatus, and a method of preparing a bed are disclosed. The apparatus includes an inflatable item having an outer wall defining a cavity for receiving a gas. The apparatus is configured to be attached to a bed against an edge barrier of the bed.

### FIELD OF THE INVENTION

Embodiments of the present invention relate to an apparatus for reducing contact pressure on a person, a bed in combination with an apparatus and a method of preparing a bed. In particular, they relate to an apparatus for reducing contact pressure on a person, a bed in combination with an apparatus and a method of preparing a bed in hospitals care homes and the like.

### BACKGROUND TO THE INVENTION

Some beds, particularly those used in hospitals, may be reconfigured to support a person in a seated position. This is achieved by raising a portion of the mattress at the head end. A problem with such an arrangement is that the person tends to slide down the bed towards its footboard, which may result in the sole of their foot pressing against the footboard. In some cases the person may not be aware of pressure being applied to their feet by the footboard over a prolonged period, for example if they have reduced sensitivity in their feet. This pressure over a prolonged period may result in pressure sores being produced on their feet.

It is also known to provide a barrier (or rails) extending along the sides of a bed, particularly those used in hospitals. Although the barrier may prevent the occupant of the bed from falling out, they also provide a hazard to that person.

### BRIEF DESCRIPTION OF VARIOUS EMBODIMENTS OF THE INVENTION

According to various, but not necessarily all, embodiments of the invention there is provided an apparatus for reducing contact pressure on a person, the apparatus comprising: an inflatable item having an outer wall defining a cavity for receiving a gas; and means for attaching the apparatus to a bed against an edge barrier of a bed.

According to various, but not necessarily all, embodiments of the invention there is provided an apparatus for reducing contact pressure on a person, the apparatus comprising an inflatable item having an outer wall defining a cavity for receiving a gas, wherein the apparatus is configured to be attached to a bed against an edge barrier of the bed.

This provides the advantage that the apparatus provides a cushioned surface to a person using the bed and prevents the edge barrier from applying high pressures to the person's skin, which might otherwise cause pressure ulcers. Pressure applied to the person by the apparatus is over a relatively large area and substantially less pressure than would be applied by an edge barrier. Furthermore the pressure applied by the apparatus is evenly distributed.

In some embodiments the apparatus further comprises an inlet valve in the outer wall configured to allow a gas to enter the cavity.

In some embodiments the apparatus further comprises a case surrounding the inflatable item and means for attaching the apparatus to a bed against an edge barrier of a bed, wherein the means for attaching are attached to the case.

In some embodiments the apparatus further comprises straps for attaching the apparatus to a bed against an edge barrier of a bed.

In some embodiments the means for attaching the apparatus to a bed comprises a buckle for attaching a strap to another strap or to another part of the apparatus. The buckle may comprise a side release buckle. The apparatus may have a relatively long edge and a relatively short edge, and a strap extending from both the relatively long edge and the relatively short edge to enable attachment to diverse edge barriers of beds. The apparatus may have two relatively long edges and two relatively short edges, two straps extending from one of the relatively long edges for extending over a footboard of a bed and two straps extending from one of the relatively short edges for extending around a side of the footboard. The apparatus may have two relatively long edges and two relatively short edges, two straps extending from each of the relatively long edges and two straps extending from each of the relatively short edges.

In some embodiments the cavity is divided into a plurality of compartments, and the compartments may be connected to enable gas to flow between the compartments. Different parts of the outer wall may be joined together to form lines separating one compartment from another compartment.

In some embodiments the apparatus further comprises a pressure release valve configured to open to allow gas to escape from the cavity only when pressure across the valve is greater than a threshold value. The pressure release valve may be configured such that gas cannot be pumped into the cavity via the pressure release valve. The threshold value may be between 0.1 pounds per square inch (6.9 mbar) and 1 pound per square inch (69 mbar).

According to various, but not necessarily all, embodiments of the invention there is provided a bed in combination with an apparatus according to any preceding paragraph attached to the bed, wherein the bed comprises a mattress and an edge barrier located along an edge of the mattress, and the apparatus is located against the edge barrier and above the mattress. The apparatus may be attached to the edge barrier. The edge barrier may be located across the foot end of the bed. The apparatus may have a length that extends substantially across the entire width of the mattress.

According to various, but not necessarily all, embodiments of the invention there is provided a method of preparing a bed comprising: locating an inflatable item above a mattress of a bed and against an edge barrier of the bed; and attaching the inflatable item to the bed.

In some embodiments, the method further comprises inflating the inflatable item with a gas.

In some embodiments, the method further comprises inflating the inflatable item with a gas after locating the inflatable item above the mattress.

In some embodiments, the step of attaching the inflatable item comprises attaching the inflatable item to the edge barrier of the bed.

### BRIEF DESCRIPTION OF THE DRAWINGS

For a better understanding of various examples of embodiments of the present invention reference will now be made by way of example only to the accompanying drawings in which:

FIG. 1 and FIG. 2 show respectively a perspective view and a cross-sectional view of an example apparatus 101A for reducing contact pressure on a person;

FIG. 3A and FIG. 3B show the apparatus 101A in use in a side view and a plan view respectively;

FIG. 4 shows a perspective view of a second example apparatus 101B;

FIG. 5A and FIG. 5B show the apparatus 101B in use in a side view and a plan view respectively;

FIG. 6 shows a perspective view of a further example apparatus 101C;

FIG. 7 shows in cross-section an end portion of compartment 202A of inflatable item 102 of apparatus 101C, the inlet valve 110 and pressure release valve 601;

FIGS. 8A and 8B show respectively a front view and a cross-sectional view of an example of a pressure release valve 601 for use with the apparatus 101A, 101B or 101C;

FIG. 9A and FIG. 9B show respectively a perspective view and a cross-sectional view of a further example apparatus 101D;

FIGS. 10A and 10B show respectively a side view and a plan view of a further example apparatus 101E in use; and

FIG. 11 shows a flow chart illustrating a method of preparing a bed.

### DETAILED DESCRIPTION OF VARIOUS EMBODIMENTS OF THE INVENTION

The Figures illustrate an apparatus 101A for reducing contact pressure on a person, the apparatus comprising: an inflatable item 102 having an outer wall 103 defining a cavity 201 for receiving a gas; and means 105 for attaching the apparatus to a bed against an edge barrier of the bed.

In examples, the means for attaching are suitable for attaching the apparatus to an edge barrier of the bed.

As used herein, the term “gas” includes pure gases, such as nitrogen and also mixtures of gases, such as air.

As used herein, the term “edge barrier of a bed” means a barrier extending upwards from the edge of the mattress of a bed. For example, an edge barrier may be a footboard, headboard or a side rail of a bed.

In embodiments of the invention, the means for attaching comprise at least one strap for location around an edge barrier of a bed or around another part of the bed. A first end of a strap may be permanently fixed to a part of the apparatus and the other end of the strap may be provided with a fastening mechanism for attaching the strap to another strap or another part, or the same part, of the apparatus. In an example, the apparatus has straps which are provided with buckles for attaching to another one of the straps. In some such examples some of the straps are provided with male parts of buckles and other straps are provided with female parts of buckles configured to engage with the male parts. In alternative embodiments the means for attaching may comprise a sheet of material which effectively provides a very broad strap, or a sheet of material that provides a pocket for extending over an edge barrier of a bed.

The outer wall 103 of the inflatable item 102 may be formed from one or more gas impermeable flexible polymer sheets 106. In an example, the sheet 106 may be formed of a microbial resistant material, which may be a type of thermoplastic polyurethane (TPU). The thermoplastic polyurethane may be a type of polyether thermoplastic polyurethane.

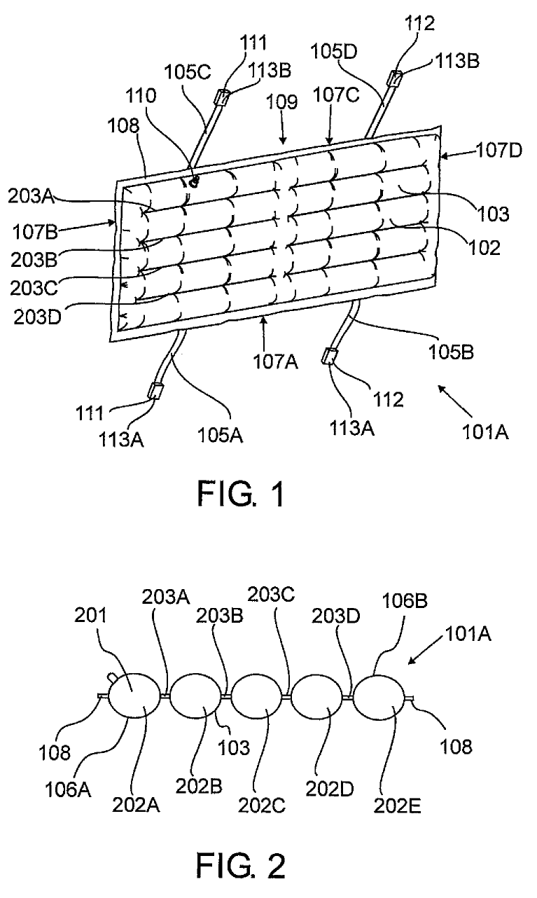

An example of an apparatus 101A for reducing contact pressure on a person is shown in the perspective view of FIG. 1 and cross-sectional view of FIG. 2.

The apparatus 101A comprises an inflatable item 102 having an outer wall 103 defining a cavity 201 (as shown in FIG. 2) for receiving a gas; and means 105 for attaching the apparatus to an edge barrier of a bed.

The cavity 201 may be formed by welding together portions of one or more sheets 106 of polymer material, for example by high frequency welding. In the present example, two sheets 106A and 106B are welded together around their edges 107A, 107B, 107C and 107D to form an airtight seal 108 around the edges.

Other portions of the sheets may be welded together to divide up the cavity into several connected compartments. Thus, in the present example, the cavity 102 has five compartments 202A, 202B, 202C, 202D and 202E arranged side by side and divided by lines of welds 203A, 203B 203C and 203D. The lines of welds are broken, in that they define gaps to enable gas to flow between the compartments. For example, the welded lines 203A, 203B 203C and 203D of apparatus 101A are provided with gaps in a middle portion 109 and also between ends of the weld lines and the edges 107B and 107D.

Although the described apparatus 101A of FIGS. 1 and 2 has only a single cavity 201, other embodiments are envisaged which have further independent cavities that may contain a pressure of gas independently of the cavity 201.

In the present embodiment, the apparatus 101A further comprises an inlet valve 110 in the outer wall 103 configured to allow a gas to enter the cavity 201. Therefore the inflatable item 102 may be inflated by pumping air through the inlet valve 110. However, alternative embodiments are envisaged without such an inlet valve. In such embodiments, the cavity 201 is filled with gas during manufacture and the seal 108 may be then completed to permanently seal in the gas.

In the present example, the apparatus 101A has means 105 for attaching the apparatus 101A to a barrier in the form of straps 105. Four straps are provided, with one end of two straps 105A and 105B permanently fixed to one edge 107A of the apparatus 101, and the other two straps having one end permanently fixed to an opposite edge 107C of the apparatus. During use each strap is connected with a strap from the opposing edge. Consequently straps 105A and 105C are provided with a fastening mechanism 111 configured fasten them together, and similarly straps 105B and 105D are provided with a fastening mechanism 111 to fasten them together. The fastening mechanisms 111 may comprise a male part 113A fixed to one strap in a connecting pair of straps (for example, 105A or 105B) and a female part 113B fixed to the other strap (for example 105C or 105D) to which it is to be connected. The fastening mechanisms may be side release buckles (or parachute buckles) which are commonly known for use on backpacks, belts, etc.

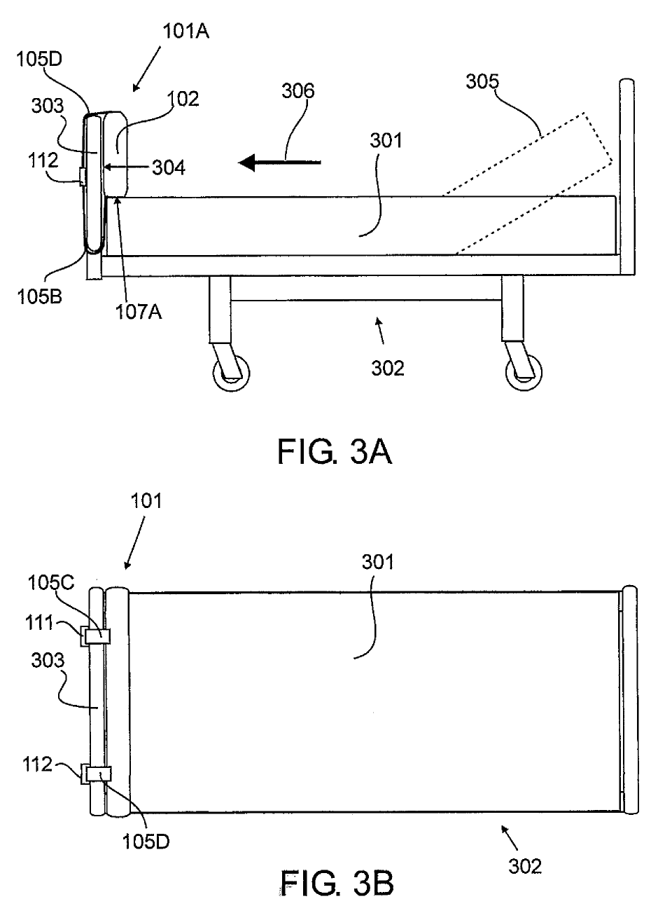

The apparatus 101A is shown in use in the side view of FIG. 3A and the plan view of FIG. 3B. The inflatable item 102 is positioned on top of an edge portion of the mattress 301 of a bed 302 with the straps 105 extending around an edge barrier 303 of the bed. In the present example, the edge barrier 303 is the footboard of the bed, which extends upwards past the edge of the mattress 301 at the foot end of the bed.

As illustrated in FIG. 3B, the inflatable item 102 is arranged to have substantially the same width as the mattress 301 of the bed 302. Thus, the inflatable item extends substantially along the entire length of the footboard 303. However, the inflatable item 102 only covers an end portion of the mattress 301 and leaves most of the top surface of the mattress free.

The inflatable item 102 is positioned on the bed 302 in an upright orientation with one edge 107A resting on the mattress 301 and one face 304 resting against the footboard 303. The straps 105C and 105D extend over the footboard 303 and have been fastened by fastening mechanisms 111 and 112 to the straps 105A (not shown in FIGS. 3A and 3B) and 105B. The straps 105A and 105B extend under a lower edge of the footboard.

The mattress 301 is shown in the figures in a flat configuration, but the mattress has a head-end portion that may be raised at an angle as illustrated by dashed line 305 to support a person in a seated position. With the mattress in this seating configuration, there is a tendency for the person on the bed to slide towards the footboard 303 as indicated by arrow 306. However, the feet of the person are prevented from coming into contact with the footboard 303 due to the presence of the inflatable item 102, which provides a cushion between the feet of the person and the footboard. The inflatable item 102 is deformable under pressure applied by a person's feet. Consequently, the area of contact between the person's feet and the inflatable item is relatively large when compared to the area of contact that might otherwise exist between their feet and the footboard if the apparatus 101 were not present. The pressure applied to the person's feet is therefore relatively small.

Furthermore, because the pressure of gas within the cavity of the inflatable item is the same throughout, the pressures applied to different parts of the contact area of the person's feet are substantially equal. Therefore, there are no parts of the person's feet that are subjected to particularly high contact pressures.

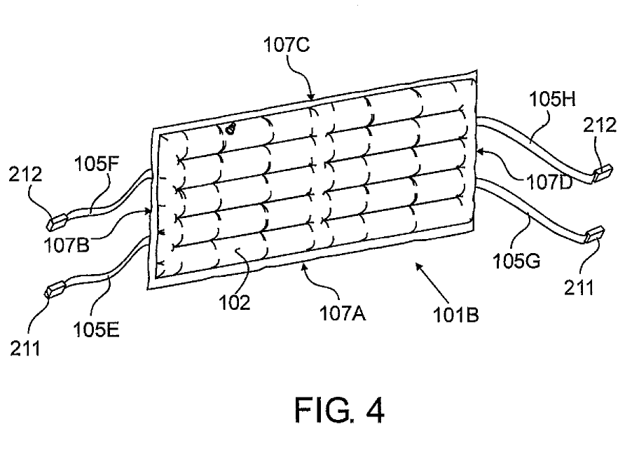

A second example apparatus 101B is shown in the perspective view of FIG. 4. The apparatus 101B comprises an inflatable item 102 which may be substantially identical to the inflatable item 102 of the apparatus 101A. Like apparatus 101A, apparatus 1018 has four straps 105, but the straps of apparatus 101B are provided in a different position and may be of a longer length. (In each apparatus 101A, 101B and the below-described 101C, the positioning of the fastening mechanisms along the straps may be adjustable as is known for backpacks, belts etc.).

The apparatus 101B has two straps 105E and 105F having one end permanently attached to a short edge 107B of the inflatable item 102 and two straps 105G and 105H permanently attached to the opposite short edge 107D. Unlike apparatus 101A, the long edges 107A and 107C of the inflatable item 102 of apparatus 101B are not provided with straps. The straps 105E and 105G are provided with a fastening mechanism 211 to enable them to be fastened together and the straps 105F and 105H are provided with a fastening mechanism 212 to enable them to be fastened together.

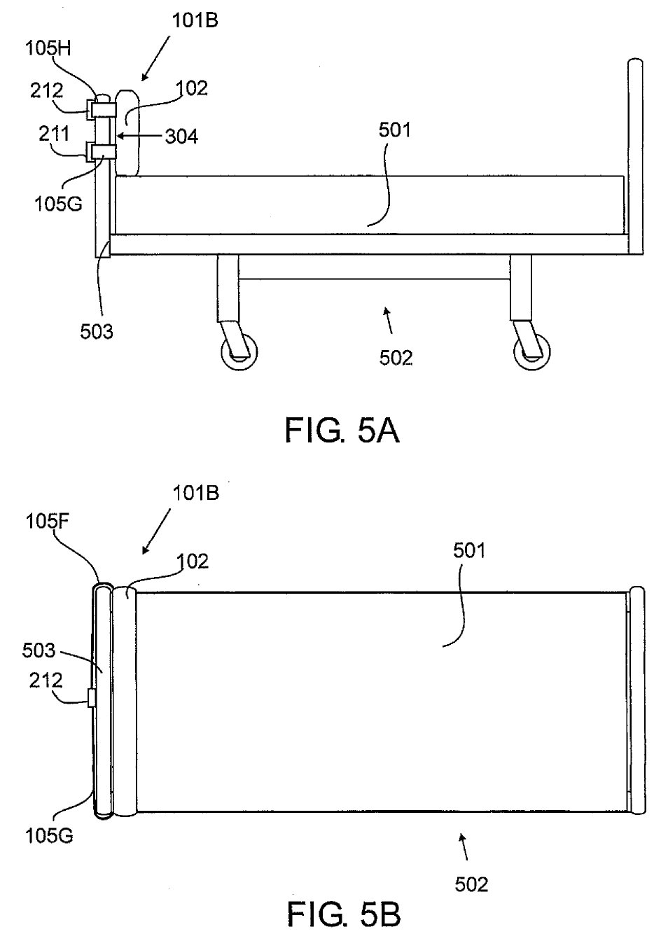

The apparatus 101B is shown in use in the side view of FIG. 5A and the plan view of FIG. 5B. The inflatable item 102 is positioned on top of the mattress 501 of a bed 502 with the straps 105 extending around a footboard 503 of the bed that extends upwards past the edge of the mattress 501.

The inflatable item 102 is positioned on the bed 502 in an upright orientation with one edge 107A resting on the mattress 501 and one face 304 resting against the footboard 303. The straps 105G and 105H extend around one side of the footboard 303 and are fastened by fastening mechanisms 211 and 212 to the straps 105E (not shown in FIGS. 5A and 5B) and 105F which extend around the opposite side of the footboard.

The apparatus 101B performs the same function as apparatus 101A. That is, it prevents the feet of a person who rests on the bed from making contact with the footboard. The feet of the person may, instead, come into contact with the inflatable item 101B which presents relatively large contact areas to the person's feet and avoids high contact pressures, as described with respect to apparatus 101A.

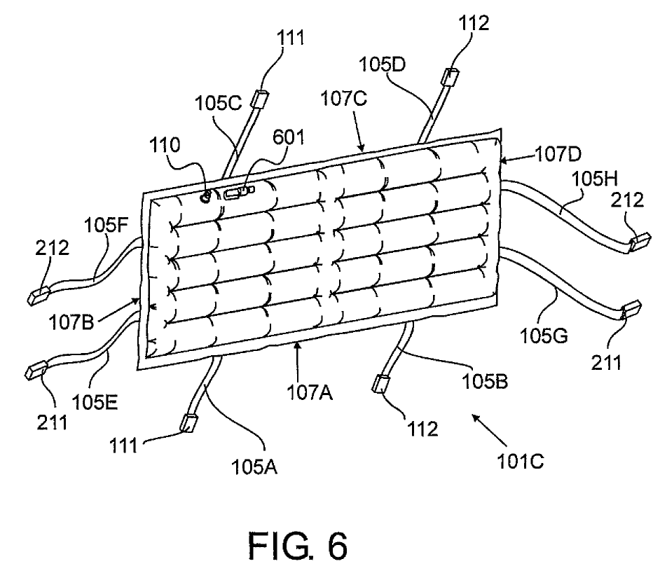

A further example apparatus 101C is shown in the perspective view of FIG. 6. The apparatus 101C has eight straps 105A to 105H. Four straps 105A, 105B, 105C and 105D of apparatus 101C are attached to the long edges 107A and 107C of the inflatable item 102, like the straps of apparatus 101A. The other four straps 105E, 105F, 105G and 105H of apparatus 101C are attached to the short edges of the inflatable item 102, like the straps of apparatus 101 B.

Having straps 105A to 105D like those of apparatus 101A and straps 105E to 105H like those of apparatus 101B enables the apparatus 101C to be attached to a barrier of a bed (such as a footboard) in the same manner as either apparatus 101A or apparatus 101B. This may be advantageous when the apparatus is to be attached to various designs of edge barriers some of which do not enable straps to be securely fastened around the sides of the barrier and some of which do not enable straps to be securely fastened around the top or bottom edges of the barrier. For example, a footboard may have rounded edges at its side and if the straps 105E to 105H were used they may not fix the apparatus to the footboard in a secure manner. Alternatively, if the footboard has a lower edge that is in contact with another part of the bed along its entire length, then it may not be possible to pass a strap over the lower edge and therefore straps 105A to 105D may not be usable.

In some cases it may be possible and preferable to use all eight straps 105A to 105H to attach the apparatus 101 C to an edge barrier of a bed.

The inflatable item 102 of apparatus 101C may be of similar construction to inflatable item 102 of apparatus 101A. However, in the present example, the inflatable item 102 comprises a pressure relief valve 601 as well as the inlet valve 110.

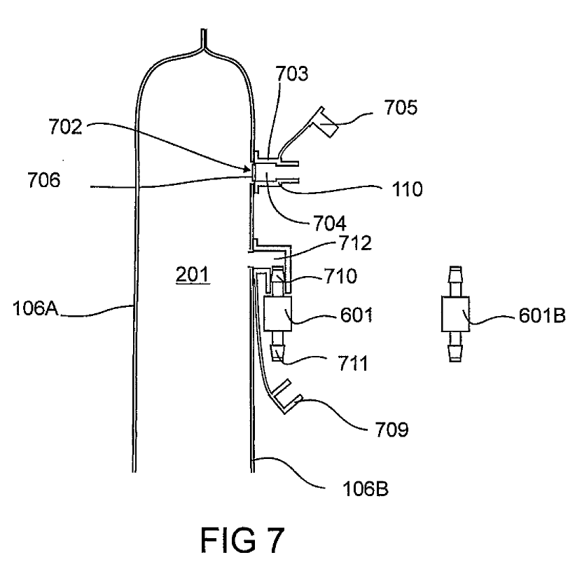

An end portion of compartment 202A of inflatable item 102 of apparatus 101C, the inlet valve 110 and pressure release valve 601 are shown in cross-section in FIG. 7. The inlet valve 110 comprises a moulded plastic inlet valve of a type known in the art and commonly used on inflatable items. The inlet valve 110 may be formed of a polymer, such as polyvinyl chloride. The inlet valve 110 is welded to the sheet 106B which forms the inflatable item, at the position of a hole 702 in the sheet. The inlet valve 110 may comprise a tube 703 defining a passageway 704 and a stopper 705 for sealing off the passageway. The passageway may be provided with a diaphragm 706 configured to allow a gas to pass into the cavity 103 of the inflatable item 102 but prevent a gas from escaping from the cavity. The valve 110 may be configured to prevent gas escaping from the cavity unless the valve is deformed under an applied force, which may be applied, for example, by squeezing between fingers.

The pressure release valve 601 is attached to the sheet 106B by a connection device 708 defining a passageway 712. The connection device 708 may be formed of a polymer suitable for welding to the polymer material of the sheet 106B.

The pressure release valve 601 is configured to allow a flow of gas in a first direction when a pressure across the valve is above a threshold value and to prevent a flow of gas in the first direction when the pressure is below the threshold value.

The pressure release valve 601 has an inlet portion 710 configured to be connected to the passageway 712 of the connection device 708. With the inlet portion 710 fitted to the connection device, as shown in FIG. 7, the pressure release valve 601 is configured to allow gas to escape from the cavity 707 when pressure of gas within the cavity is more than the threshold value above the ambient air pressure and to prevent gas escaping from the cavity when pressure of gas within the cavity not more than the threshold value above ambient air pressure.

The inlet portion of the pressure release valve 601 is configured to be connected to the connection device 708 of the inflatable item 102 such that it is detachable. Consequently, the pressure release valve 601 may be removed and replaced with another valve such as pressure release valve 601B. The pressure release valve 601B may be formed in a similar manner to pressure release valve 601 but configured to allow a flow of gas when a pressure across the pressure release valve 601B is above a second threshold value that is different to the threshold value of the pressure release valve 601. Thus, by having several different valves, such as pressure release valve 601 and pressure release valve 601B, the pressure within the cavity may be maintained at or below a chosen threshold value above ambient air pressure.

In use, with the pressure release valve 601 fitted, the inflatable item 102 may be inflated by pumping a gas through the inlet valve 110. When pressure within the cavity exceeds the threshold value for the pressure release valve 601, the gas is able to escape through the pressure release valve 601. After pumping is stopped, the pressure within the cavity may drop until, the pressure in the cavity 103 is equal to ambient atmospheric air pressure plus the threshold value for the pressure release valve 601.

In examples, the valves 601 and 601B are configured to open when the pressure difference between the inlet and the outlet of the valve is greater than a pressure difference of between 0.1 pounds per square inch (6.9 mbar) and 1 pound per square inch (69 mbar). Therefore, the threshold value is such that the pressure in the cavity is greater than ambient atmospheric pressure by between 0.1 pounds per square inch (6.9 mbar) and 1 pound per square inch (69 mbar).

In some of these examples, the valves 601 and 601 B are configured to open when the pressure difference between the inlet and the outlet of the valve is greater than a pressure difference of between 0.15 pounds per square inch (10.3 mbar) and 0.8 pounds per square inch (55 mbar). Therefore, the threshold value is such that the pressure in the cavity is greater than atmospheric pressure by between 0.15 pounds per square inch (10.3 mbar) and 0.8 pounds per square inch (55 mbar).

In some of these examples, the valves 601 and 601B are configured to open when the pressure difference between the inlet and the outlet of the valve is greater than a pressure difference of between 0.2 pounds per square inch (14 mbar) and 0.5 pounds per square inch (35 mbar).

Although the pressure release valve 601 is described here as fitted to apparatus 101C, it should be understood that the apparatuses 101A and 101B may include such a pressure release valve.

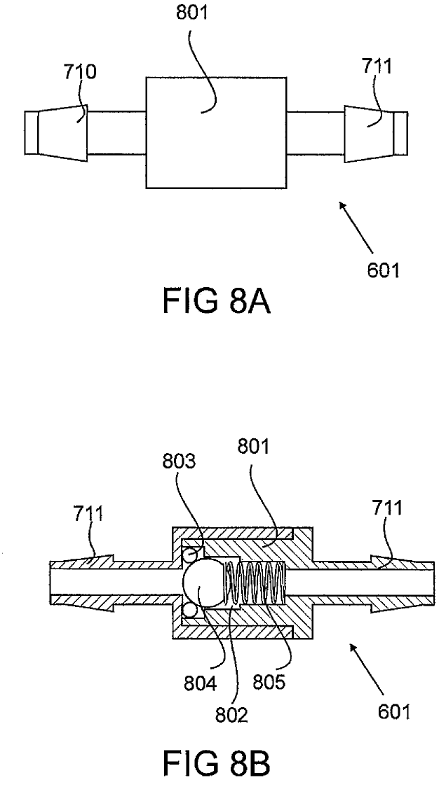

An example of a pressure release valve 601 for use with the apparatus 101A, 101B or 101C is a check valve. An example of a suitable valve is shown in the front view and cross-sectional view of FIGS. 8A and 8B.

The pressure release valve 601 comprises a main body 801 between the inlet portion 710 and the outlet portion 711. The inlet portion and outlet portion define passageways that extend inwards to a central chamber 802 in the main body 801. The central chamber contains an O-ring which forms a valve seat 803 and a ball 804 configured to rest against the valve seat 803 to form a seal. The central chamber 802 also contains a compression spring 805 configured to urge the ball against the valve seat 803 to maintain the valve in the closed configuration shown in FIG. 8B. However, when sufficient gas pressure is applied to the inlet side of the ball 804, the ball is forced against the force of the spring 805 away from the valve seat to allow gas to pass around the ball and through the valve.

As will be understood from FIG. 8B, the pressure release valve 601 is also configured to prevent any flow of gas from its outlet to its inlet, and therefore the inflatable item cannot be inflated through the pressure release valve 601.

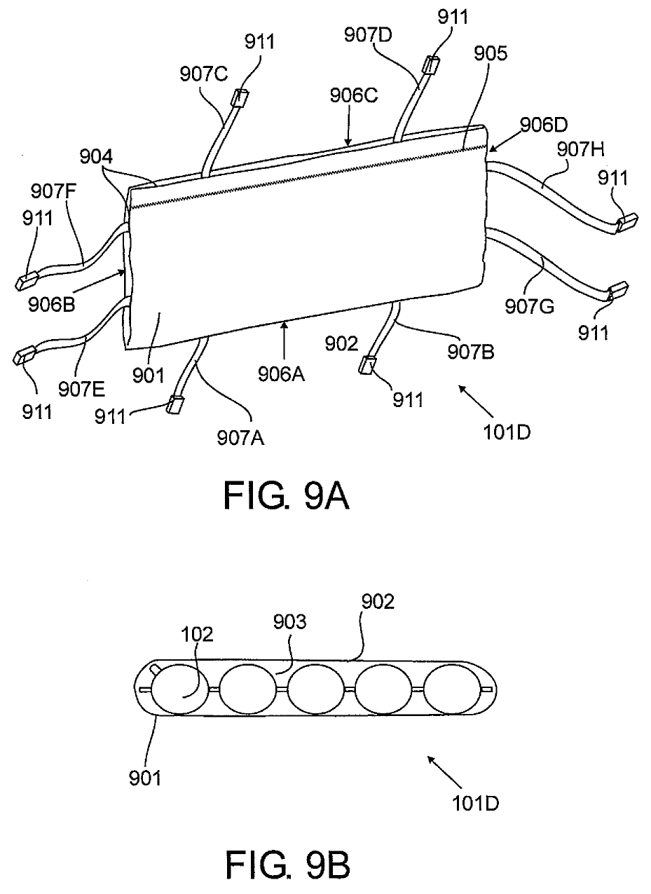

A further example of an apparatus 101D is shown in the perspective view of FIG. 9A and the cross-sectional view of FIG. 9B. The apparatus 101D comprises an inflatable member 102 which may be of the same construction as inflatable member 102 of apparatus 101A, 101B or 101C, but it may not have any straps attached to it.

The apparatus 101D also comprises an outer case 901 in which the inflatable item is located. The outer case 901 is in the form of a bag 902 comprising a single compartment 903 in which the inflatable item 102 is locatable. The bag 902 may be formed of one or more sheets of material that are joined together at seams, such as seams 904. The sheets of material may also be joined along a line by a zip (or zipper) 905. In the present example, a zip 905 is provided on one face of the bag 902 and extends from one edge 906B of the bag to the opposite edge 906D. The zip 905 may be opened to allow the inflatable item 102 to be inserted, removed and/or replaced, or to merely further inflate or deflate the inflatable item if required.

The sheets of material that form the bag 902 may be continuous sheets of a polymer material that are waterproof to enable the case to be cleaned and dried by wiping.

The case 901 also comprises one or more means for attaching the apparatus 101D to an edge barrier of a bed, such as a footboard or side rails. In the present example, the means for attaching comprise one or more straps 907 for location around the edge barrier. The straps 907 of apparatus 101D may be arranged like those of apparatus 101A, 101B or (as illustrated in FIG. 9A) like those of apparatus 101C. Therefore, two straps may be attached to each of the four edges 906A, 906B, 906C and 906D of the bag 902.

The straps 907 may have one end permanently attached to the bag 902, for example, by incorporating the end of the strap into a seam that joins sheets of material forming the bag.

Other parts of the straps may be provided with fastening mechanisms 911 for fastening a strap to another one of the straps or for fastening to the same strap or another part of the case to form a loop. The fastening mechanisms may be buckles or other known types of fastening mechanism that may be used for connecting straps together, such as D-rings, buttons, etc.

The present example apparatus 101D may be used in the same manner as apparatuses 101A, 101B or 1010. Like apparatus 101C, the apparatus has straps 907 on each of its four edges and therefore it may be attached to an edge barrier of a bed using the four straps extending from the shorter edges 906B and 906D of the bag, or the four straps extending from the two longer edges 906A and 906C of the bag, or using all eight straps.

The inflatable item 102 of apparatus 101D has similar dimensions to that of apparatus 101A, 101B and 101C and is intended for use on a footboard of a bed.

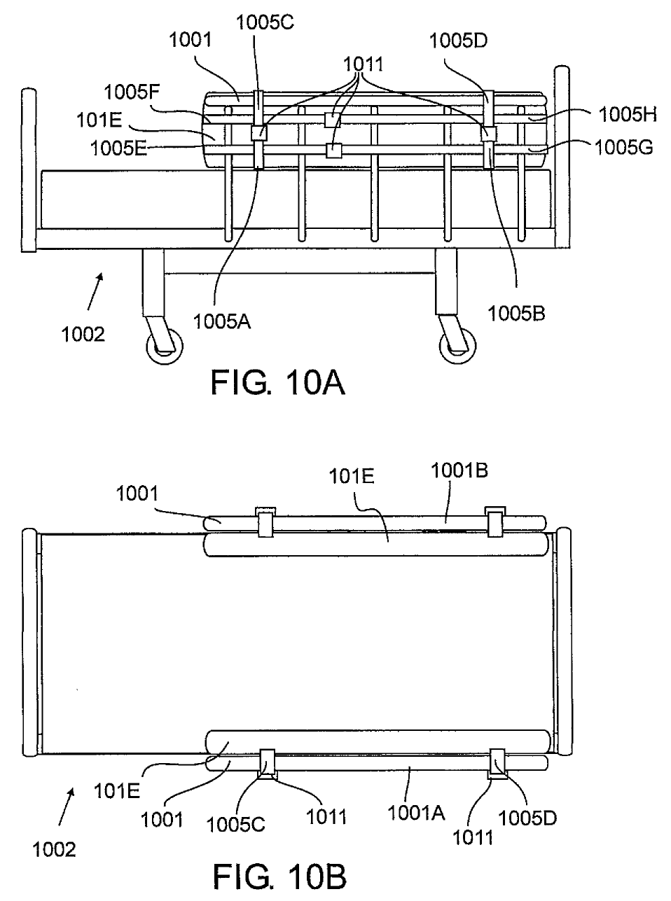

A further example apparatus 101E is shown in use in a side view and plan view in FIGS. 10A and 10B respectively. A first apparatus 101E is attached to a left side rail 1001A while a second apparatus 1001E is attached to the right side rail 1001B.

The apparatus 101E is substantially the same as apparatus 101D except that it has a longer length. The length of the apparatus 101E has been arranged to match the length of the side rails 1001 of the bed 1002. In an alternative example, the side rails extend substantially along the entire length of the mattress, and the apparatus 101E is dimensioned to similarly extend along the entire length of the mattress.

The apparatus 101E has two straps 1005A and 1005B which are fixed to a long edge 1006A and two straps 1005C and 1005D which are fixed to an opposite long edge 1006C. The apparatus 101E also has two straps 1005E and 1005F which are fixed to a short edge 1006B and two straps 1005G and 1005H which are fixed to an opposite short edge 1006D. The straps on opposing edges of the apparatus extend around the side rails and are connected together by fastening mechanisms 1011.

In each of the above described examples, the apparatus is provided with straps that are used to attach the apparatus to an edge barrier of the bed. However, other embodiments are envisaged in which the apparatus is provided with means for attaching the apparatus to another part of a bed, such as the mattress or the frame supporting the mattress. For example, in some embodiments, straps are provided at each end of one edge of the apparatus. That edge of the apparatus is then positioned on the mattress, so that the apparatus is against the edge barrier of the bed and the straps are fastened around the mattress and/or the frame of the bed which supports the mattress.

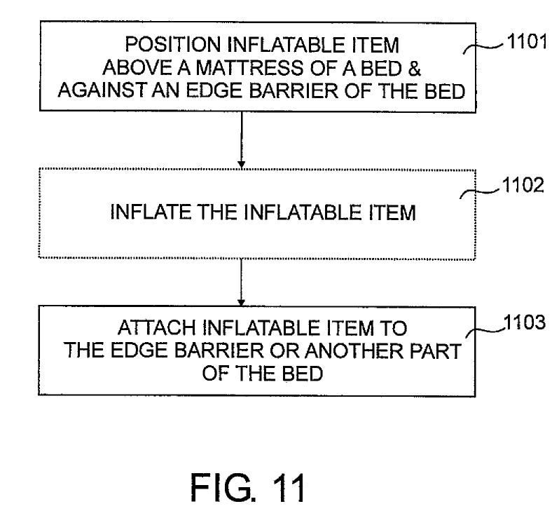

A method of preparing a bed is shown in the flow chart of FIG. 11. At block 1101 of the method, an inflatable item is located above a mattress of a bed and against an edge barrier of the bed. The inflatable item may be pre-inflated, or if it is not the inflatable item is inflated with a gas at block 1102. At block 1103 the inflatable item may be attached to the edge barrier or another part of the bed.

The illustration of a particular order to the blocks in FIG. 11 does not necessarily imply that there is a required or preferred order for the blocks and the order and arrangement of the blocks may be varied. For example, block 1102, if required, may be performed before block 1101 or after block 1103. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for reducing contact pressure on a person, the apparatus comprising an inflatable item having an outer wall defining a cavity for receiving a gas, wherein the apparatus is configured to be attached to a bed against an edge barrier of the bed.

2. An apparatus according to claim 1, wherein the apparatus further comprises an inlet valve in the outer wall configured to allow a gas to enter the cavity.

3. An apparatus according to claim 1, wherein the apparatus further comprises a case surrounding the inflatable item and straps for attaching the apparatus to a bed against an edge barrier of a bed, wherein the straps are attached to the case.

4. An apparatus according to claim 1, wherein the apparatus further comprises straps for attaching the apparatus to a bed against an edge barrier of a bed.

5. An apparatus according to claim 4, wherein the apparatus comprises a buckle for attaching one of the straps to another one of the straps or to another part of the apparatus.

6. An apparatus according to claim 5, wherein the buckle comprises a side release buckle.

7. An apparatus according to claim 4, wherein the apparatus has a relatively long edge and a relatively short edge, and a strap extending from both the relatively long edge and the relatively short edge to enable attachment to diverse edge barriers of beds.

8. An apparatus according to claim 4, wherein the apparatus has two relatively long edges and two relatively short edges, two straps extending from one of the relatively long edges for extending over a footboard of a bed and two straps extending from one of the relatively short edges for extending around a side of the footboard.

9. An apparatus according to claim 4, wherein the apparatus has two relatively long edges and two relatively short edges, two straps extending from each of the relatively long edges and two straps extending from each of the relatively short edges.

10. An apparatus according to claim 1, wherein the cavity is divided into a plurality of compartments, and the compartments are connected to enable gas to flow between the compartments.

11. (canceled)

12. An apparatus according to claim 1, further comprising a pressure release valve configured to open to allow gas to escape from the cavity only when pressure across the valve is greater than a threshold value.

13. An apparatus according to claim 12, wherein the pressure release valve is configured such that gas cannot be pumped into the cavity via the pressure release valve.

14. An apparatus according to claim 12, wherein the threshold value is between 0.1 pounds per square inch (6.9 mbar) and 1 pound per square inch (69 mbar).

15. A bed in combination with an apparatus according to claim 1 attached to the bed, wherein the bed comprises a mattress and an edge barrier located along an edge of the mattress, and the apparatus is located against the edge barrier and above the mattress.

16. A bed in combination with an apparatus as claimed in claim 15, wherein the apparatus is attached to the edge barrier.

17. A bed in combination with an apparatus as claimed in claim 15, wherein the edge barrier is located across the foot end of the bed.

18. A bed in combination with an apparatus as claimed in claim 17, wherein the apparatus has a length that extends substantially across the entire width of the mattress.

19. A method of preparing a bed comprising:
locating an inflatable item above a mattress of a bed and against an edge barrier of the bed; and
attaching the inflatable item to the bed.

20. (canceled)

21. A method of preparing a bed according to claim 19 further comprising inflating the inflatable item with a gas after locating the inflatable item above the mattress.

22. A method of preparing a bed according to claims 19, wherein the step of attaching the inflatable item comprises attaching the inflatable item to the edge barrier of the bed.
